(19) United States
(12) Patent Application Publication
(10) Pub. No.: US 2026/0203162 A1
(43) Pub. Date: Jul. 16, 2026

(54) METHOD AND SYSTEM FOR FAULT RECOVERY OF VIDEO LINK, ELECTRONIC DEVICE AND STORAGE MEDIUM

(71) Applicant: Apollo Intelligent Driving Technology (Beijing) Co., Ltd., Beijing (CN)

(72) Inventor: Lingshuai MENG, Beijing (CN)

(21) Appl. No.: 19/565,858

(22) Filed: Mar. 13, 2026

(30) Foreign Application Priority Data
Nov. 14, 2025 (CN) 202511677437.3

(51) Int. Cl. G06F 11/07

(52) U.S. Cl. CPC G06F 11/0793; G06F 11/0733

(57) ABSTRACT

Provided is a method and a system for fault recovery of a video link, an electronic device and a storage medium, relating to the field of autonomous driving technology, and in particular to the fields of data transmission, image processing and fault diagnosis technologies. The method includes: initiating an error event handling task in response to an interrupt signal of an error event; wherein the interrupt signal is used to indicate that a target video link is faulty, and the target video link comprising a target camera and a vehicle-carried controller connected to the target camera; and performing fault recovery on a fault location in the target video link based on an interrupt type corresponding to the interrupt signal and information of the target camera.

### CROSS-REFERENCE TO RELATED APPLICATIONS

The present application claims priority to Chinese Patent Application No. CN202511677437.3, filed with the China National Intellectual Property Administration on Nov. 14, 2025, the disclosure of which is hereby incorporated herein by reference in its entirety.

### TECHNICAL FIELD

The present disclosure relates to the field of autonomous driving technology, and in particular to the fields of data transmission, image processing and fault diagnosis technologies.

### BACKGROUND

A vehicle-carried camera and a vehicle-carried controller of an autonomous vehicle are usually connected by wiring harness. In order to improve the transmission distance of camera data, the camera data may be input into a serializer to convert the camera data into serial data, and then the serial data is transmitted to the vehicle-carried controller through the wiring harness. Then, the serial data is converted by the deserializer into a data format that the vehicle-carried controller can recognize. The data output by the deserializer is typically processed using a System on Chip (SOC).

### SUMMARY

The present disclosure provides a method and an apparatus for fault recovery of a video link, a device and a storage medium.

According to one aspect of the present disclosure, provided is a method for fault recovery of a video link, including:
initiating an error event handling task in response to an interrupt signal of an error event; where the interrupt signal is used to indicate that a target video link is faulty, and the target video link including a target camera and a vehicle-carried controller connected to the target camera; and
performing fault recovery on a fault location in the target video link based on an interrupt type corresponding to the interrupt signal and information of the target camera.

According to another aspect of the present disclosure, provided is an apparatus for fault recovery of a video link, including:
an interrupt module configured to initiate an error event handling task in response to an interrupt signal of an error event; where the interrupt signal is used to indicate that a target video link is faulty, and the target video link including a target camera and a vehicle-carried controller connected to the target camera; and
a recovery module configured to perform fault recovery on a fault location in the target video link based on an interrupt type corresponding to the interrupt signal and information of the target camera.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flowchart of a method for fault recovery of a video link according to an embodiment of the present disclosure;

FIG. 2 is a schematic flowchart of a method for fault recovery of a video link according to another embodiment of the present disclosure;

FIG. 3 is a schematic diagram of a video link;

FIG. 4 is a schematic diagram of a video link including a plurality of cameras;

FIG. 5 is a schematic flowchart of a method for fault recovery of a video link according to another embodiment of the present disclosure;

FIG. 6 is a topology diagram of a video link in an application scenario;

FIG. 7 is a topology diagram of a video link with a plurality of cameras for an application scenario;

FIG. 8 is a flowchart of a method for fault detection and recovery of a video link for autonomous driving;

FIG. 9 is a flowchart of generating interrupt 1;

FIG. 10 is a flowchart of generating interrupt 2;

FIG. 11 is a flowchart of an event handling method;

FIG. 12 is a structural schematic diagram of an apparatus for fault recovery of a video link according to an embodiment of the present disclosure;

FIG. 13 is a structural schematic diagram of an apparatus for fault recovery of a video link according to another embodiment of the present disclosure; and

FIG. 14 is a block diagram of an electronic device for implementing the method of the embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

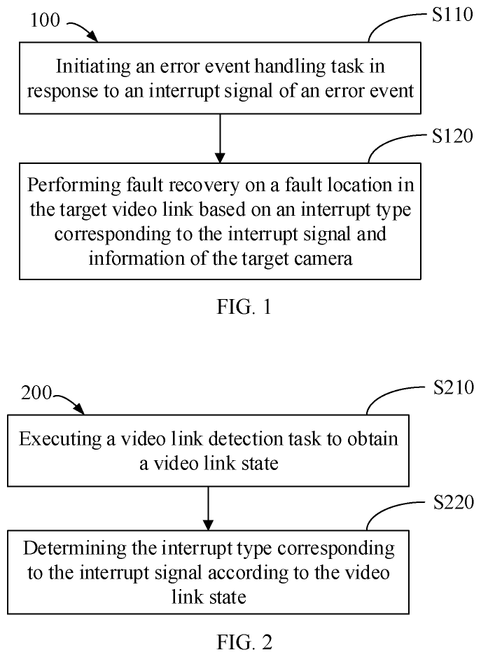

FIG. 1 is a schematic flowchart of a method 100 for fault recovery of a video link according to an embodiment of the present disclosure. The method includes:
S110: initiating an error event handling task in response to an interrupt signal of an error event; where the interrupt signal is used to indicate that a target video link is faulty, and the target video link including a target camera and a vehicle-carried controller connected to the target camera; and
S120: performing fault recovery on a fault location in the target video link based on an interrupt type corresponding to the interrupt signal and information of the target camera.

In the embodiment of the present disclosure, the video link in the vehicle may include a vehicle-carried camera and a vehicle-carried controller. If a plurality of vehicle-carried cameras are connected to the vehicle-carried controller, the vehicle may include a plurality of video links. After the data such as video data collected by an image collection device such as webcam in the vehicle-carried camera is converted by a serializer into serial data, the serial data may be converted by a deserializer in the vehicle-carried controller into a data format that the vehicle-carried controller can recognize. During operation, the vehicle system such as autonomous driving system may experience a video link fault (or link error, link anomaly, etc.) due to a problem with any component of the camera or controller in the video link. In the case of detecting a video link has a large number of faults or reaches an event trigger threshold, an interrupt signal may be generated for this video link (i.e., the target video link). In this case, the access unit in the vehicle-carried controller may initiate an error event handling task corresponding to the interrupt signal in response to the interrupt signal indicating that the target video link is faulty.

In the embodiment of the present disclosure, the target camera that may appear or the target video link where the target camera is located can be positioned based on the source of the interrupt signal. For example, if an interrupt signal originates from camera C1, the video link where C1 is located may include an image collection device and a serializer inside C1, a serializer connected or communicating with the serializer of C1, a processor such as an Image Signal Processor (ISP), an access unit and others, and communication links between these components. Different types of interrupt signals may indicate different types of error events. The error events may include events that the video link may be faulty. For example, the interrupt types corresponding to interrupt signals may include: error indication signal Input/Output (IO) interrupt (corresponding to an IO error event) and autonomous driving service layer interrupt (corresponding to an error event of the autonomous driving service layer), etc. The interrupt signal corresponding to the error indication signal IO interrupt may be sent by the deserializer to the access unit; and the interrupt signal corresponding to the autonomous driving service layer interrupt may be sent by the service layer or computing unit to the access unit, or may be generated by the access unit itself based on the number of dropped frames in the service layer. After determining the target camera link or target camera based on the source of the interrupt signal, the access unit may execute the corresponding event handling task for the interrupt type corresponding to the interrupt signal. For example, the error event handling task of the autonomous driving service layer is executed based on the autonomous driving service layer interrupt; and the IO error event handling task is executed based on the error indication signal IO interrupt. During the execution of the error event handling task, it is possible to determine which specific component of the camera, deserializer, ISP or access unit is the fault location in the target video link, thereby performing fault recovery on the fault location, for example, controlling the faulty camera to restart, controlling the faulty deserializer to reset, controlling the faulty ISP to reset, or controlling the video interface circuit module of the faulty access unit to reset, etc.

According to the embodiment of the present disclosure, the fault location of the target video link can be accurately positioned by using the interrupt type corresponding to the interrupt signal and the information of the target camera, thereby recovering the fault location, improving the fault positioning accuracy and shortening the fault recovery time. Furthermore, this method, when applied to an autonomous driving system, can improve the stability of the autonomous driving system.

FIG. 2 is a schematic flowchart of a method 200 for fault recovery of a video link according to another embodiment of the present disclosure. In one implementation, method 200 further includes:
S210: executing a video link detection task to obtain a video link state; and
S220: determining the interrupt type corresponding to the interrupt signal according to the video link state.

In the embodiment of the present disclosure, the fault detection may be performed in combination with timed triggering and event triggering. The video link detection task may include a timed detection task, and the timed triggering may be achieved by the timed detection task. The timed detection task may also be called periodic detection task, and the state detection may be performed on each video link according to a set period to obtain the video link state of each video link.

In one implementation, the video link state includes one or more of:
State 1: the number of consecutive dropped frames counted from the video data received by the access unit from all channels.
State 2: error state of the video interface of the access unit; for example, Cyclic Redundancy Check (CRC) error, Forward Error Correction (FEC) error, etc.
State 3: the number of consecutive dropped frames counted based on the input and output video data of the ISP (ISP frame count error).
State 4: error state of input and output interfaces of the ISP, for example, CRC error, ECC error, etc.
State 5: error state of the input interface of the deserializer (deserializer error), for example, physical layer disconnection, physical layer CRC error, FEC error reaching an error threshold, physical signal eye width or eye height being less than a preset threshold, etc.

In the embodiment of the present disclosure, the video link state of each video link may be accumulated during the execution of the timed detection task. When a certain state reaches the event trigger condition, the interrupt signal corresponding to the error event may be triggered (which may also be understood as generating a breakpoint). In response to the interrupt signal, the video link detection task (such as timed detection task) may be suspended (or interrupted), and the error event handling task corresponding to the interrupt signal may be started to enter the event handling process. When the execution of the error event handling task is finished, the video link detection task may be resumed. Pausing the video link detection task while executing the error event handling task can quickly recover from the link fault and improve the fault recovery efficiency.

According to the embodiment of the present disclosure, the link errors of all components of the video link can be accurately counted from different link states, facilitating quick selection of the corresponding recovery method and improving the processing efficiency after a fault occurs.

In the embodiment of the present disclosure, the video link state may be continuously detected and recorded. The video link states may include various states to indicate errors, such as states 1 to 5 mentioned above. No interrupt signal will be generated in some states, while interrupt signals may be generated if the interrupt conditions are met in some states. For example, if state 5 includes disconnection of the physical layer, a first interrupt signal (an error indication signal IO interrupt signal) may be generated. For another example, if the cumulative number of consecutive dropped frames of the ISP input and output video data in state 3 exceeds a set threshold, a second interrupt signal (an autonomous driving service layer interrupt signal) may be generated. When the interrupt signal of the target video link is detected, the interrupt type can be determined first based on the interrupt signal. For example, if the interrupt signal is the second interrupt signal, the interrupt type is determined to be autonomous driving service layer interrupt, and the error event handling task corresponding to the autonomous driving service layer interrupt may be executed. If the interrupt signal is the first interrupt signal, the interrupt type is determined to be IO interrupt, and the error event handling task corresponding to the IO interrupt may be executed.

According to the embodiment of the present disclosure, the video link state is detected by the video link detection task, it is judged according to the video link state whether an interrupt signal is generated, and then the corresponding event processing task may be executed according to the interrupt type corresponding to the interrupt signal, improving the fault handling efficiency, shortening the fault recovery time, and reducing the risk of system failure.

In one implementation, the step of determining the interrupt type corresponding to the interrupt signal according to the video link state includes:
receiving a first interrupt signal from a deserializer of the vehicle-carried controller, where the first interrupt signal corresponds to a first interrupt type; and the first interrupt signal is generated by the deserializer when monitoring a preset error type in the video link state of the target video link.

In one implementation, the error type includes one or more of: physical layer disconnection, a physical layer Cyclic Redundancy Check (CRC) error, a Forward Error Correction (FEC) error reaching an error threshold, a physical signal eye width being less than a preset threshold, or a physical signal eye height being less than a preset threshold.

In the embodiment of the present disclosure, a relevant error register such as deserializer may be arranged to store the error type detected by executing the timed detection task during the initialization phase. For example, if the physical layer corresponding to a deserializer is detected to be disconnected, an identifier corresponding to the disconnection of the physical layer or a mark position bit corresponding to the disconnection of the physical layer may be stored in the register of this deserializer. The register may also store the detected physical layer CRC errors, FEC errors and number thereof, physical signal eye width, physical signal eye height, etc. The deserializer may trigger the error indication signal IO to drop and generate the first interrupt signal if the deserializer detects any one or more of the following error types: physical layer disconnection, physical layer CRC error, FEC error reaching the error threshold, physical signal eye width being less than the preset threshold, or physical signal eye height being less than the preset threshold. Then the deserializer may send the first interrupt signal to the access unit. After receiving the first interrupt signal from the deserializer, the access unit determines the target video link where the deserializer is located according to the source of the first interrupt signal, and then performs fault location and fault recovery for all components of the vehicle-carried camera and vehicle-carried controller included in the target video link according to the first interrupt type.

In the embodiment of the present disclosure, the physical layer disconnection may indicate that a connection interruption has occurred at the physical layer, resulting in the inability to transmit signals among various components of the video link. The physical layer CRC error may indicate an abnormality in the integrity of a data packet detected by the CRC algorithm during physical layer transmission. The FEC error reaching the threshold may indicate that the receiving end in the communication link still has residual errors that have not been corrected (or the number of error corrections exceeds a preset limit) after correcting errors through the FEC algorithm, triggering a system alarm or protection mechanism and generating an interrupt signal.

In the embodiment of the present disclosure, thresholds may also beset for the eye width and eye height of the physical signal, respectively. In high-speed serial communication (such as GMSL), eye diagrams may be used to assess signal integrity. The eye width and eye height are key parameters in eye diagrams, and may reflect the quality and reliability of signals. The GMSL is a serial communication technology designed specifically for high-speed multimedia data transmission in vehicles, and is mainly used to connect vehicle-carried cameras, radars and other sensors with domain controllers, and is a key data transmission link in autonomous driving and smart cockpit systems.

The eye diagram is a graphic formed by superimposing serial signals at the receiving end according to the clock cycle: the horizontal axis represents the time (synchronized with the clock), and the vertical axis represents the signal voltage (high level is “1” and low level is “0”). Ideally, the superimposed signals will form an eye-like shape, where the larger the blank area (“pupil”) in the middle, the better the signal quality. Eye Width: measure the timing margin: the width of the “pupil” on the horizontal axis (time axis) in the eye diagram, representing a timing tolerance range of a signal before and after the optimal sampling time (unit: usually ps or ns). Eye Height: measure the voltage margin: the height of the “pupil” on the vertical axis (voltage axis) in the eye diagram, representing a voltage amplitude margin of a signal at the optimal sampling time (unit: usually mV or V). When the physical signal eye width is less than the preset threshold, meaning that the timing jitter of the signal is large, the timing tolerance decreases, so that the receiving end cannot accurately obtain the signal level information during sampling, thereby increasing the bit error rate. When the physical signal eye height is less than the preset threshold, it indicates that the signal amplitude has been attenuated or affected by factors such as crosstalk and jitter, resulting in a reduction in the noise tolerance of the signal. As a result, the signal is more susceptible to noise interference during transmission, making it difficult for the receiver to accurately distinguish between the states “1” and “0” of the signal, and thus increasing the bit error rate. An interrupt signal needs to be generated at this point.

According to the embodiment of the present disclosure, the deserializer monitors the error type and sends an interrupt signal to the access unit when an error occurs, so that a timely response to the link anomaly can be made, facilitating quick and accurate fault localization and diagnosis.

In one implementation, the step of determining the interrupt type corresponding to the interrupt signal according to the video link state further includes:
counting the number of dropped frames in the target video link according to the video link state; and
generating a second interrupt signal when the number of dropped frames reaches an interrupt trigger threshold, where the second interrupt signal corresponds to a second interrupt type.

In the embodiment of the present disclosure, if too many frames are dropped during the transmission of the service layer, the continuity and integrity of the video data will be destroyed. Therefore, it is necessary to count the number of dropped frames in the target video link. The event trigger threshold may be set according to the service layer's requirement for camera frame interval. When consecutive frame drops reach the threshold, an event interruption will be triggered. The requirement for camera frame interval may represent the time interval standard between two consecutive frames of images output by the camera, and may be determined by the frame rate (Frames Per Second, FPS) (frame interval=1/frame rate). To reserve time for recovery of the video link, the event interrupt threshold may be set to the maximum number of consecutive dropped frames required by the service layer minus one frame. For example, when the maximum number of consecutive dropped frames required by the service layer is n, the interrupt trigger threshold may be set to n−1.

In the embodiment of the present disclosure, the frame rate data of multiple branch cameras may further be counted by the access unit, and the ISP judges whether the number of consecutive dropped frames reaches the threshold (n−1). When the number of consecutive dropped frames reaches the threshold, the event interrupt is triggered. The judgment method may include: the ISP communicates with the access unit through the Mobile Industry Processor Interface (MIPI) protocol, and the access unit makes a judgment from the number of Frame Starts and Frame Ends within a preset time period. The MIPI is a series of high-speed serial communication protocol standards developed by the MIPI Alliance, mainly for connections between processors and peripherals in mobile devices (such as smartphones, tablets, and vehicle-carried smart terminals). The Frame Start and Frame End are signals or fields identifying boundaries of a complete data frame, and are used to enable the receiving end to correctly identify “start and end points of a data frame” and ensure that the data is completely parsed. The access unit may read the recorded video link state, count the frame rate of each camera, and judge whether the number of consecutive dropped frames reaches the threshold n−1. If so, the second interrupt signal may be generated (or the second interrupt type may be directly determined). The access unit may also receive the second interrupt signal from the service layer (or computing unit). The second interrupt signal may be service layer interrupt.

According to the embodiment of the present disclosure, the number of dropped frames in the target video link may be monitored by the vehicle-carried controller. When frame drops occur, anomalies can be detected in a timely manner, facilitating fault diagnosis and localization, and ensuring the video quality.

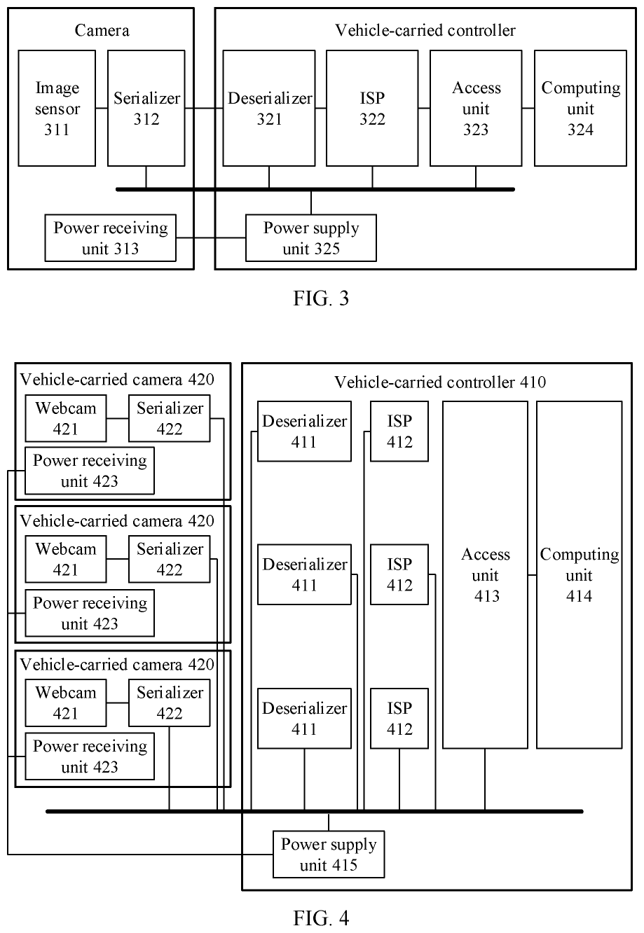

In one implementation, a schematic diagram of a video link is shown in FIG. 3. The target camera 310 includes an image sensor 311, a serializer 312 and a power receiving unit 313; the vehicle-carried controller 320 includes a deserializer 321, an Image Signal Processor (ISP) 322, an access unit 323, a computing unit 324 and a power supply unit 325; the serializer 312 is connected to the deserializer 321, and the deserializer 321 is connected to the ISP 322.

In one implementation, a schematic diagram of a video link including a plurality of cameras is shown in FIG. 4. The video link includes a vehicle-carried controller 410 and a plurality of vehicle-carried cameras 420. The vehicle-carried controller includes a deserializer 411, an ISP 412, an access unit 413, a computing unit 414, and a power supply unit 415. One camera includes a webcam 421, a serializer 422, and a power receiving unit 423. The serializer 422 of each camera is connected to one deserializer 411, and each deserializer 411 is connected to one ISP 412. A plurality of ISPs 412 are jointly connected to one access unit 413.

One or more of the deserializer 411, ISP 412, access unit 413, computing unit 414 and power supply unit 415 may be connected via an Inter-Integrated Circuit (IIC, also known as FC). The IIC is a two-wire synchronous serial communication bus consisting of a serial data line (SDA) and a serial clock line (SCL), and can greatly simplify circuit wiring and is mainly used for data transmission between short-distance, low-speed integrated circuits. The control signal between the access unit 413 and the deserializer 411 is an IIC signal, the control signal between the access unit 413 and the ISP 412 is also an IIC signal, the control signal between the access unit 413 and the power supply unit 415 is also an IIC signal, and a plurality of cameras can share one IIC.

According to the embodiment of the present disclosure, the image quality can be improved by processing the data output by the deserializer through the ISP, and the computing power can be improved by separating the access unit from the computing unit, thereby improving the overall processing efficiency. In addition, the vehicle-carried controller is connected to the cameras via the IIC without laying multiple control cables separately for the cameras, reducing the complexity of hardware design, allowing for obtaining the camera state and finding the camera problem in real time, and thus reducing faults.

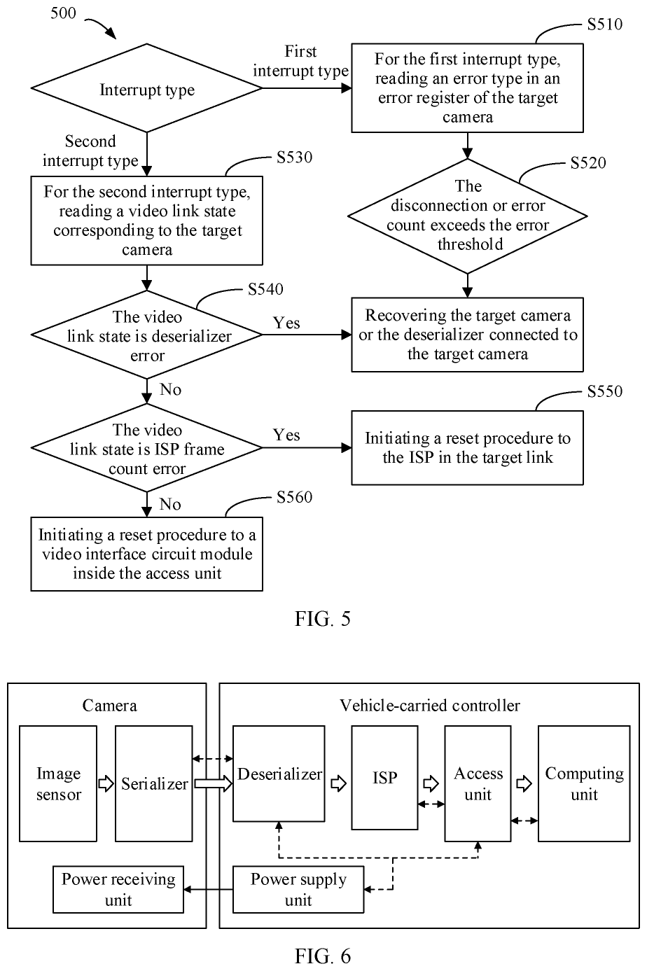

FIG. 5 is a schematic flowchart of a method for fault recovery of a video link according to another embodiment of the present disclosure. The method 500 may be used to implement step S120 in the method 100 for fault recovery of the video link. In one implementation, the method 500 includes: performing fault recovery on a fault location in the target video link based on an interrupt type corresponding to the interrupt signal and information of the target camera, further including:
S510: for the first interrupt type, reading an error type in an error register of the target camera; and
S520: recovering the target camera or the deserializer connected to the target camera when determining based on the error type that the target camera is disconnected or the number of errors exceeds an error threshold.

In the embodiment of the present disclosure, an approach may be: when determining that the interrupt type is not the second interrupt type, reading the error state and error type stored in the error register, and judging whether the first interrupt type corresponding to the first interrupt signal has been generated. Another approach may be: when receiving the first interrupt signal and determining it to be of the first interrupt type, reading the error state and error type stored in the error register, and verifying according to the error register whether the first interrupt type corresponding to the first interrupt signal has been generated. The error register may be arranged in the vehicle-carried controller and/or vehicle-carried camera. The error types stored in the error register may include physical connection state(s) of the camera and/or deserializer, CRC, FEC, eye width and eye height, etc.

In the embodiment of the present disclosure, the serial number of the target camera may be determined by the IO error signal source, and the error state of the target camera recorded in the error register may be read. If the physical connection state of the target camera is camera disconnection (physical layer disconnection), an interrupt may be generated (for example, a first interrupt signal is generated or determined to belong to the first interrupt type). If a certain type of error that can be accumulated is detected, the error count of the target camera may be incremented by one, and an interrupt may be generated when the error count exceeds the error threshold. For example, the error threshold for the same type of error is set to 3, and the error threshold for all types of errors is set to 5. When the error count does not exceed the error threshold, the error count is incremented by one, the error register is cleared, and the indicator pin state is restored to the initial state to wait for the next interrupt. When the error count exceeds the error threshold, an interrupt is generated (e.g., a first interrupt signal is generated or determined to be of the first interrupt type), and the recovery operation may be performed on the camera or deserializer. The recovery operation may be, for example, restarting the camera, resetting the deserializer, etc. Then, the error count is cleared to zero, the error register is cleared, and the indicator pin state is restored to the initial state to wait for the next interrupt.

According to the embodiment of the present disclosure, multiple errors can be counted before fault recovery through the error types in the error register, facilitating flexible control of fault recovery for different error types, and thereby implementing fault recovery more reasonably.

In one implementation, the step of performing fault recovery on a fault location in the target video link based on an interrupt type corresponding to the interrupt signal and information of the target camera, further includes:
S530: for the second interrupt type, reading a video link state corresponding to the target camera; and
S540: recovering the target camera or the deserializer connected to the target camera when the video link state is deserializer error.

In the embodiment of the present disclosure, when the interrupt type corresponding to the interrupt signal is the second interrupt type, such as autonomous driving service layer interrupt, the access unit may determine the sequence number of the target camera and read the link state of the video link corresponding to the target camera. Here, the link state of the video link may be detected by the link state detection method described above. The link state may include, for example, the state of the access unit, the state of the ISP interface, the state of the deserializer, etc., as shown in the relevant examples described above. For example, if the link state of the target camera is detected to be the deserializer error state illustrated in state 5, the target camera in the target camera link may be restarted, or the deserializer connected to the target camera may be reset, etc.

According to the embodiment of the present disclosure, the deserializer error can be accurately positioned by the video link state, thereby enabling rapid recovery of the deserializer or the camera connected thereto, and improving the fault recovery efficiency.

In one implementation, S520 or S540 of recovering the target camera or the deserializer connected to the target camera further includes:
sending a power-off command and then a power-on command to the power supply unit to control the target camera to restart;
checking a connection state of the target camera after the target camera restarts; and
initiating a reset procedure to the deserializer connected to the target camera when the connection state is non-recovery.

In the embodiment of the present disclosure, when the deserializer reports an error or disconnection is determined according to the error register or the error count exceeds the error threshold, the access unit may first determine that the camera is faulty, and send the power-off command and then the power-on command to the power supply unit through the control interface to restart the target camera. For example, the access unit sends the power-off command and then the power-on command for camera C1 to the power supply unit; and the power supply unit first stops supplying power to the power receiving unit of camera C1, and then supplies power to the power receiving unit of camera C1 again. In this way, the image acquisition unit and serializer of camera C1 can be restarted. If the connection between the target camera and the vehicle-carried controller is not restored after restarting, the link fault may be not caused by the camera fault, or the camera fault may have been recovered but there is still link fault caused by other problems. In this case, the deserializer may be determined to be faulty, and a reset command is further sent to the deserializer, to control the deserializer to execute the reset procedure to restore the connection. If the link connection is restored, the error count may be cleared to zero, the error register may be cleared, and the indicator pin state may be restored to the initial state to wait for the next interrupt.

According to the embodiment of the present disclosure, the target link connection can be quickly restored by restarting the camera, and it can be ensured that the link returns to normal by checking the connection state of the target camera after restarting. If restarting the camera does not restore the connection, the deserializer can be further reset to troubleshoot and restore the connection.

In one implementation, the step of performing fault recovery on a fault location in the target video link based on an interrupt type corresponding to the interrupt signal and information of the target camera, further includes:
S550: initiating a reset procedure to the ISP in the target link when the video link state is ISP frame count error.

In the embodiment of the present disclosure, if the video link state is not deserializer error but ISP frame count error (e.g., the input and output frame counts of the ISP are unequal), the reset procedure may be initiated for the ISP to restore the connection thereof. The ISP includes an input interface and an output interface, and the input interface and output interface of the ISP may be monitored respectively to obtain the operating states of the input interface and output interface of the ISP. If the number of video data frames at the input interface is unequal to the number of video data frames at the output interface, the number of consecutive dropped frames counted from the input and output video data of the ISP may be recorded in the video link state. If the number of dropped frames exceeds the threshold, a second interrupt signal may be generated. When the video link state is read in response to the second interrupt signal and the ISP frame count error is found, the ISP fault may be determined, and the link fault recovery may be performed by resetting the ISP.

According to the embodiment of the present disclosure, the fault location and recovery can be achieved by detecting the ISP error, reducing the need for accurate judgment of whether the ISP is faulty, improving the accuracy of fault location, and maintaining the normal quality and processing accuracy of the image frame rate.

In one implementation, the step of performing fault recovery on a fault location in the target video link based on an interrupt type corresponding to the interrupt signal and information of the target camera, further includes:
S560: initiating a reset procedure to a video interface circuit module inside the access unit when the link state is neither deserializer error nor ISP frame count error.

In the embodiment of the present disclosure, if the state detection of the target video link reveals that neither the deserializer error nor the ISP frame count error is present, the video interface circuit module inside the access unit may be faulty. In this case, a reset and initialization procedure may be performed on the video interface circuit module to restore the connection thereof. The video interface circuit module inside the access unit may be connected to a plurality of cameras. The interface connected to the faulty target camera may be reset, or the entire video interface circuit module may be reset.

According to the embodiment of the present disclosure, resetting the video interface circuit module through the access unit can uniformly restore the link parameter configuration, prevent the spread of faults, and reduce the frequency of manual maintenance.

The serializer of the vehicle-carried camera in the autonomous vehicle converts the camera data into serial data, which is then transmitted to the autonomous driving domain controller (vehicle-carried controller) via wiring harness. Then, the serial data is converted by the deserializer of the vehicle-carried controller into a data format that the controller can recognize. To obtain high-quality images, the autonomous vehicle may use a ISP (Image Signal Processor) chip. In pursuit of computing power, the access unit of the camera data and the computing unit may be separated. The embodiment of the present disclosure can perform fault detection and recovery on the video link in autonomous driving, accurately locate faults when problems occur, and handle faults in time after faults occur, thereby preventing faults from being missed and eliminating faults in a timely manner.

The method for fault recovery of the video link provided in the embodiments of the present disclosure can be used for fault detection and recovery of the video link in autonomous driving. The topology of the video link in an application scenario is shown in FIG. 6 below:

The blank arrows represent the direction of video data; the dashed arrows represent control signals, commonly including IIC/UART/IO/SPI, etc.; and the types of control signals are not fixed. An example scheme of the embodiment of the present disclosure is as follows:

The IIC data is transmitted between the serializer and deserializer via GMSL/FPD-LINK, etc.

The FPD-LINK (Flat Panel Display Link) is a high-speed digital video interface standard that can aggregate and transmit data of multiple industry-wide common protocols.

The control signal between the access unit and the deserializer is an IIC signal, the reset signal is an IO signal (from the access unit to the deserializer), and the error indication signal is an IO signal (from the deserializer to the access unit).

The control signal between the access unit and the ISP is an IIC signal, and additionally, the reset signal is an IO signal (from the access unit to the ISP).

The control signal is transmitted between the computing unit and the access unit via an SPI signal.

The solid arrow represents the power supply direction; and the power supply for the camera module may be provided by the vehicle-carried controller. The vehicle-carried controller and the camera are connected by wiring harness for power supply and control signals, and the video data shares one physical channel.

The UART (Universal Asynchronous Receiver/Transmitter) is a universal asynchronous serial communication interface that can convert data between serial and parallel formats and is widely used for data transmission between short-distance and medium/low-speed devices. The UART consists of a transmitter, a receiver, and a baud rate generator.

The SPI (Serial Peripheral Interface) is a high-speed, full-duplex synchronous serial communication protocol that is widely used for data transmission between short-distance and high-speed chips. The SPI bus contains at least four signal lines (some lines may be omitted in some simplified scenarios):

Serial Clock (SCLK): generated by the master device to control the rhythm of data transmission.

Master Out, Slave In (MOSI): the master device sends data to the slave device through this line.

Master In, Slave Out (MISO): the slave device returns data to the master device through this line.

Chip Select/Slave Select (CS/SS): the master device selects a slave device by pulling down the CS line thereof (low level is valid), and unselected slave devices do not respond to communication.

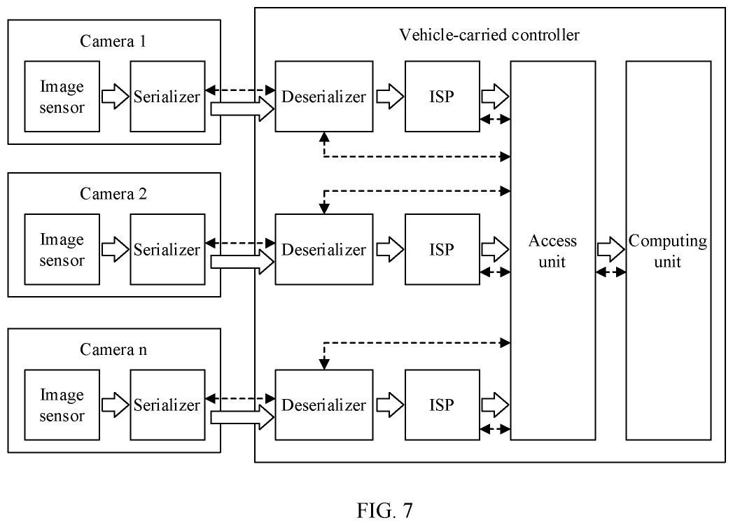

The above describes the case of a single camera. In actual applications of autonomous driving, there may be n (n≥10) cameras (camera 1, camera 2, . . . camera n, etc.) as shown in FIG. 7. The control signal between the access unit and the deserializer is an IIC signal, the control signal between the access unit and the ISP is an IIC signal, and the control signal between the access unit and the power supply unit is an IIC signal (not shown in the figure). To save resources or due to hardware limitations, the access unit will not allocate one IIC communication interface to each device. Multiple (e.g., 2 to 6) cameras share one IIC communication interface, and addresses are used to distinguish for time-division communication. Therefore, if the fault state information of each device is polled and read periodically, the cycle will be lengthened (there is a need to read sequentially according to time), resulting in poor real-time monitoring. The method proposed in the embodiment of the present disclosure can effectively solve the problem of poor real-time monitoring, and can achieve accurate fault location when the problem occurs and recovery after the fault occurs.

Exemplary application scenarios in the autonomous driving system include:
1. Self-test at the start stage of the autonomous vehicle;
2. Monitor and troubleshoot during operation of the autonomous driving system.

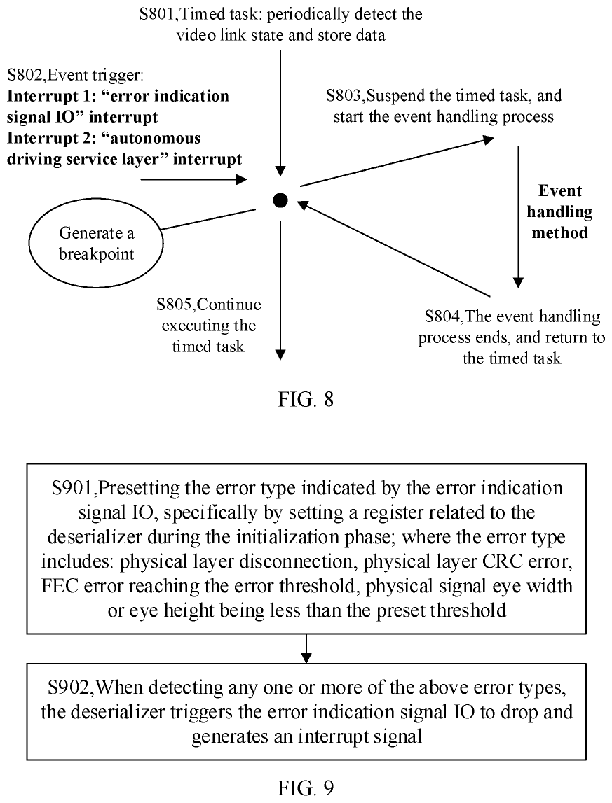

A method for fault detection and recovery of a video link for autonomous driving includes: a fault detection method in combination with timed triggering and event triggering. As shown in FIG. 8, the method may specifically include the following process:
S801: normal operation: regularly detecting the link state, assessing the health, and formulating a response strategy. Specifically, a timed task may be first run to periodically (regularly) detect the video link state and store the detection data (including the video link state).
S802: event trigger: detecting an error event and generating an interrupt (or a breakpoint), such as interrupt 1: “error indication signal IO” interrupt; interrupt 2: “autonomous driving service layer” interrupt.
S803: preempting the timed task after generating the interrupt. The timed task is suspended, the event handling process is started, the event handling method is executed, the error event is prioritized for handling, and the response strategy is formulated.
S804: the event handling process ends, and return to the timed task.
S805: continue executing the timed task.

As shown in FIG. 9, the process of generating the interrupt 1 includes:
S901: presetting the error type indicated by the error indication signal IO, specifically by setting a register related to the deserializer during the initialization phase; where the error type includes: physical layer disconnection, physical layer CRC error, FEC error reaching the error threshold, physical signal eye width or eye height being less than the preset threshold.
S902: when detecting any one or more of the above error types, the deserializer triggers the error indication signal IO to drop, and generates an interrupt signal.

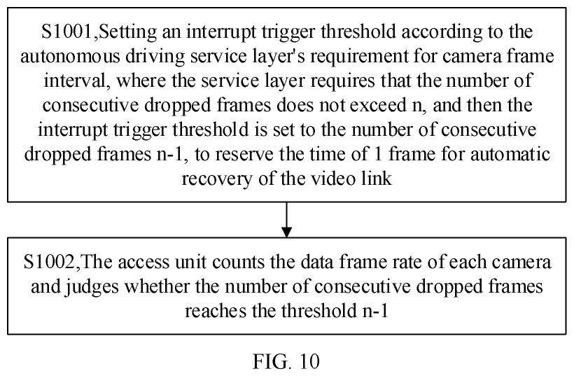

As shown in FIG. 10, the process of generating the interrupt 2 includes:
S1001: setting an interrupt trigger threshold according to the autonomous driving service layer's requirement for camera frame interval, where the service layer requires that the number of consecutive dropped frames does not exceed n (n≥2 and n≤5), and then the interrupt trigger threshold is set to the number of consecutive dropped frames n−1, to reserve the time of 1 frame for automatic recovery of the video link.
S1002: the access unit counts the data frame rate of each camera and judges whether the number of consecutive dropped frames reaches the threshold n−1 (an example of the judgment method: the ISP communicates with the access unit through the MIPI protocol, and the access unit makes a judgment by judging the number of frame starts and frame ends in the MIPI protocol within a preset time period).

As shown in the table below, examples of periodically detecting the video link state include:

| Serial Number | State Type |
|---|---|
| 1 | The number of consecutive dropped frames counted from video data |
| | received by access unit from all channels |
| 2 | Error state of video interface of access unit, including CRC error and |
| | ECC error |
| 3 | The number of consecutive dropped frames counted from input and |
| | output video data of ISP |
| 4 | Error state of input and output interfaces of ISP, including CRC error |
| | and ECC error |
| 5 | Error state of input interface of deserializer, including physical layer |
| | disconnection, physical layer CRC error, FEC error reaching the error |
| | threshold, and physical signal eye width or eye height being less than |
| | the preset threshold |

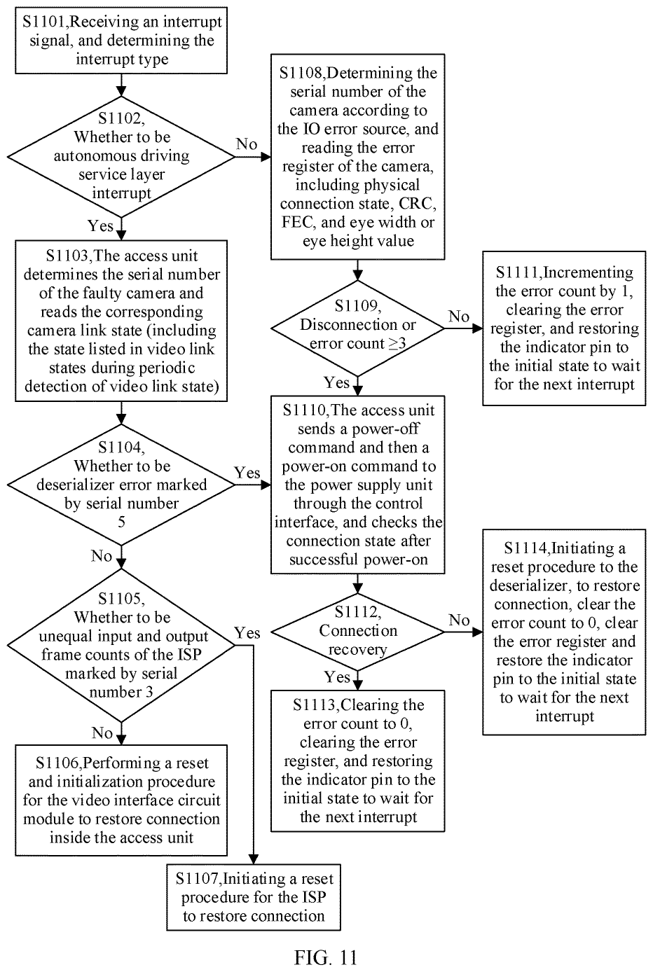

The flowchart of an event handling method is shown in FIG. 11 below:
S1101: receiving an interrupt signal, and determining the interrupt type.
S1102: judging whether the interrupt type is an autonomous driving service layer interrupt. If yes, proceed to step S1103; otherwise, proceed to step S1108.
S1103: the access unit determines the serial number of the faulty camera and reads the corresponding camera link state (including the state listed in video link states during periodic detection of video link state).
S1104: judging whether the camera link state is deserializer error (marked by serial number 5). If yes, proceed to step S1110; otherwise, proceed to step S1105.
S1105: judging whether the camera link state is unequal input and output frame counts of the ISP (marked by serial number 3). If yes, proceed to step S1107; otherwise, proceed to step S1106.
S1106: performing a reset and initialization procedure for the video interface circuit module to restore connection inside the access unit.
S1107: initiating a reset procedure for the ISP to restore connection.
S1108: determining the serial number of the camera according to the IO error source, and reading the error register of the camera, including physical connection state, CRC, FEC, and eye width or eye height value.
S1109: judging whether the disconnection or error count in the error register is greater than or equal to a set threshold, such as ≥3. If yes, proceed to step S1110; otherwise, proceed to step S1111.
S1110: the access unit sends a power-off command and then a power-on command to the power supply unit through the control interface, and checks the connection state after successful power-on. Then, proceed to step S1112.
S1111: incrementing the error count by 1, clearing the error register, and restoring the indicator pin to the initial state to wait for the next interrupt.
S1112: judging whether the connection is restored. If yes, proceed to step S1113; otherwise, proceed to step S1114.
S1113: clearing the error count to 0, clearing the error register, and restoring the indicator pin to the initial state to wait for the next interrupt.
S1114: initiating a reset procedure to the deserializer, to restore connection, clear the error count to 0, clear the error register and restore the indicator pin to the initial state to wait for the next interrupt.

The embodiment of the present disclosure provides a fault detection method in combination with timed triggering and event triggering. The normal operations of regularly detecting the link state, assessing the health and formulating the response strategy can monitor the device/data state of the entire video link. Combined with event triggering, an error event is detected, an interruption occurs, and a timed task is preempted to prioritize handling the error event, allowing for formulating the response strategy in real time; and a corresponding link fault recovery strategy is proposed, fully considering requirements of autonomous driving services, restoring the faulty link to normal without affecting autonomous driving services, significantly improving the reliability and fault handling capability of the autonomous driving video link, and enabling data recovery without human intervention in the event of fault.

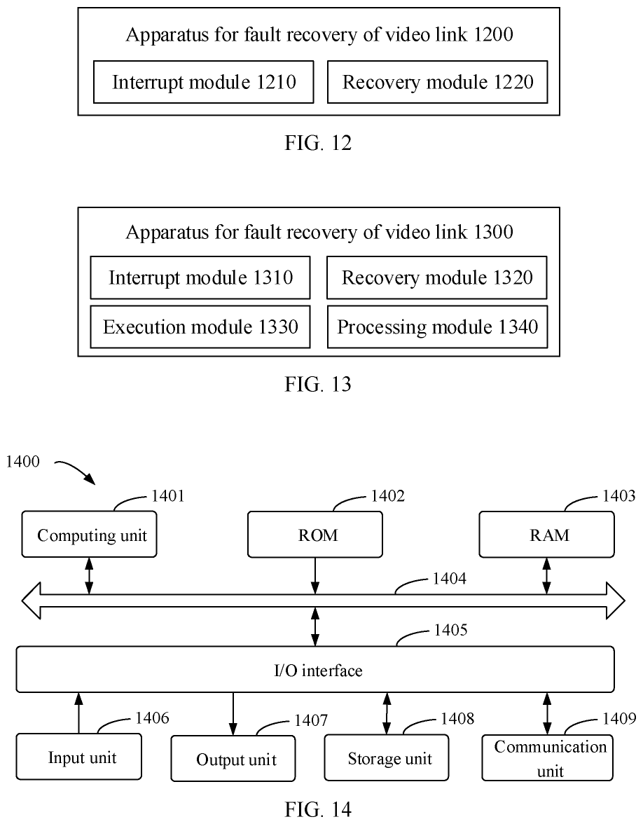

FIG. 12 is a structural schematic diagram of an apparatus 1200 for fault recovery of a video link according to an embodiment of the present disclosure. The apparatus 1200 may include:
an interrupt module 1210 configured to initiate an error event handling task in response to an interrupt signal of an error event; where the interrupt signal is used to indicate that a target video link is faulty, and the target video link including a target camera and a vehicle-carried controller connected to the target camera; and
a recovery module 1220 configured to perform fault recovery on a fault location in the target video link based on an interrupt type corresponding to the interrupt signal and information of the target camera.

FIG. 13 is a structural schematic diagram of an apparatus 1300 for fault recovery of a video link according to another embodiment of the present disclosure. The apparatus 1300 includes an interrupt module 1310 and a recovery module 1320. The functions of the above modules can refer to the functions of the modules of the apparatus for fault recovery of the video link in the above embodiment. In one implementation, the apparatus 1300 further includes:
an execution module 1330 configured to execute a video link detection task to obtain a video link state; and
a processing module 1340 configured to determine the interrupt type corresponding to the interrupt signal according to the video link state.

In one implementation, the processing module 1340 is further configured to receive a first interrupt signal from a deserializer of the vehicle-carried controller, where the first interrupt signal corresponds to a first interrupt type; and the first interrupt signal is generated by the deserializer when monitoring a preset error type in the video link state of the target video link.

In one implementation, the error type includes one or more of: physical layer disconnection, a physical layer CRC error, an FEC error reaching an error threshold, a physical signal eye width being less than a preset threshold, or a physical signal eye height being less than a preset threshold.

In one implementation, the processing module 1340 is further configured to count the number of dropped frames in the target video link according to the video link state; and generate a second interrupt signal when the number of dropped frames reaches an interrupt trigger threshold, where the second interrupt signal corresponds to a second interrupt type.

In one implementation, the target camera includes an image sensor, a serializer and a power receiving unit; the vehicle-carried controller includes a deserializer, an ISP, an access unit, a computing unit and a power supply unit; the serializer is connected to the deserializer, and the deserializer is connected to the ISP.

In one implementation, the recovery module 1320 is configured to, for the first interrupt type, read an error type in an error register of the target camera; and recover the target camera or the deserializer connected to the target camera when determining based on the error type that the target camera is disconnected or the number of errors exceeds an error threshold.

In one implementation, the recovery module 1320 is further configured to, for the second interrupt type, read a video link state corresponding to the target camera; and recover the target camera or the deserializer connected to the target camera when the video link state is deserializer error.

In one implementation, the recovery module 1320 is further configured to send a power-off command and then a power-on command to the power supply unit to control the target camera to restart; check a connection state of the target camera after the target camera restarts; and initiate a reset procedure to the deserializer connected to the target camera when the connection state is non-recovery.

In one implementation, the recovery module 1320 is further configured to initiate a reset procedure to the ISP in the target link when the video link state is ISP frame count error.

In one implementation, the recovery module 1320 is further configured to initiate a reset procedure to a video interface circuit module inside the access unit when the link state is neither deserializer error nor ISP frame count error.

In one implementation, the video link state includes one or more of:
the number of consecutive dropped frames counted from video data received by an access unit from all channels;
error state of a video interface of the access unit;
the number of consecutive dropped frames counted based on input and output video data of an ISP;
error state of input and output interfaces of the ISP; or
error state of an input interface of a deserializer.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

FIG. 14 shows a schematic block diagram of an exemplary electronic device 1400 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 14, the device 1400 includes a computing unit 1401 that may perform various appropriate actions and processes according to a computer program stored in a Read-Only Memory (ROM) 1402 or a computer program loaded from a storage unit 1408 into a Random Access Memory (RAM) 1403. Various programs and data required for operations of the device 1400 may also be stored in the RAM 1403. The computing unit 1401, the ROM 1402 and the RAM 1403 are connected to each other through a bus 1404. The input/output (I/O) interface 1405 is also connected to the bus 1404.

A plurality of components in the device 1400 are connected to the I/O interface 1405, and include an input unit 1406 such as a keyboard, a mouse, or the like; an output unit 1407 such as various types of displays, speakers, or the like; the storage unit 1408 such as a magnetic disk, an optical disk, or the like; and a communication unit 1409 such as a network card, a modem, a wireless communication transceiver, or the like. The communication unit 1409 allows the device 1400 to exchange information/data with other devices through a computer network such as the Internet and/or various telecommunication networks.

The computing unit 1401 may be various general-purpose and/or special-purpose processing components with processing and computing capabilities. Some examples of the computing unit 1401 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1401 performs various methods and processes described above, such as the method for fault recovery of the video link. For example, in some implementations, the method for fault recovery of the video link may be implemented as a computer software program tangibly contained in a computer-readable medium, such as the storage unit 1408. In some implementations, a part or all of the computer program may be loaded and/or installed on the device 1400 via the ROM 1402 and/or the communication unit 1409. When the computer program is loaded into the RAM 1403 and executed by the computing unit 1401, one or more steps of the method for fault recovery of the video link described above may be performed. Alternatively, in other implementations, the computing unit 1401 may be configured to perform the method for fault recovery of the video link by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for fault recovery of a video link, comprising:
initiating an error event handling task in response to an interrupt signal of an error event; wherein the interrupt signal is used to indicate that a target video link is faulty, and the target video link comprising a target camera and a vehicle-carried controller connected to the target camera; and
performing fault recovery on a fault location in the target video link based on an interrupt type corresponding to the interrupt signal and information of the target camera.

2. The method of claim 1, further comprising:
executing a video link detection task to obtain a video link state; and
determining the interrupt type corresponding to the interrupt signal according to the video link state.

3. The method of claim 2, wherein the determining of the interrupt type corresponding to the interrupt signal according to the video link state, comprises:
receiving a first interrupt signal from a deserializer of the vehicle-carried controller, wherein the first interrupt signal corresponds to a first interrupt type; and the first interrupt signal is generated by the deserializer in a case where a preset error type is monitored in the video link state of the target video link.

4. The method of claim 3, wherein the error type comprises one or more of: physical layer disconnection, a physical layer Cyclic Redundancy Check (CRC) error, a Forward Error Correction (FEC) error reaching an error threshold, a physical signal eye width being less than a preset threshold, or a physical signal eye height being less than a preset threshold.

5. The method of claim 2, wherein the determining of the interrupt type corresponding to the interrupt signal according to the video link state, comprises:
counting the number of dropped frames in the target video link according to the video link state; and
generating a second interrupt signal, in a case where the number of dropped frames reaches an interrupt trigger threshold, wherein the second interrupt signal corresponds to a second interrupt type.

6. The method of claim 5, wherein the target camera comprises an image sensor, a serializer and a power receiving unit; the vehicle-carried controller comprises a deserializer, an Image Signal Processor (ISP), an access unit, a computing unit and a power supply unit; the serializer is connected to the deserializer, and the deserializer is connected to the ISP.

7. The method of claim 6, wherein the performing of the fault recovery on the fault location in the target video link based on the interrupt type corresponding to the interrupt signal and the information of the target camera, comprises:
for the first interrupt type, reading an error type in an error register of the target camera; and
recovering the target camera or the deserializer connected to the target camera, in a case where it is determined, based on the error type, that the target camera is disconnected or the number of errors exceeds an error threshold.

8. The method of claim 6, wherein the performing of the fault recovery on the fault location in the target video link based on the interrupt type corresponding to the interrupt signal and the information of the target camera, comprises:
for the second interrupt type, reading a video link state corresponding to the target camera; and
recovering the target camera or the deserializer connected to the target camera, in a case where the video link state is deserializer error.

9. The method of claim 8, wherein the recovering of the target camera or the deserializer connected to the target camera, further comprises:
sending a power-off command and then a power-on command to the power supply unit to control the target camera to restart;
checking a connection state of the target camera after the target camera restarts; and
initiating a reset procedure to the deserializer connected to the target camera, in a case where the connection state is non-recovery.

10. The method of claim 8, wherein the performing of the fault recovery on the fault location in the target video link based on the interrupt type corresponding to the interrupt signal and the information of the target camera, further comprises:
initiating a reset procedure to the ISP in the target link, in a case where the video link state is ISP frame count error.

11. The method of claim 8, wherein the performing of the fault recovery on the fault location in the target video link based on the interrupt type corresponding to the interrupt signal and the information of the target camera, further comprises:
initiating a reset procedure to a video interface circuit module inside the access unit, in a case where the link state is neither deserializer error nor ISP frame count error.

12. The method of claim 2, wherein the video link state comprises one or more of:
the number of consecutive dropped frames counted from video data received by an access unit from all channels;
error state of a video interface of the access unit;
the number of consecutive dropped frames counted based on input and output video data of an ISP;
error state of input and output interfaces of the ISP; or
error state of an input interface of a deserializer.

13. A system for fault recovery of a video link, comprising: a vehicle-carried camera and a vehicle-carried controller; wherein the vehicle-carried camera comprises an image sensor, a serializer and a power receiving unit; the vehicle-carried controller comprises a deserializer, an ISP, an access unit, a computing unit and a power supply unit; the serializer is connected to the deserializer; the deserializer is connected to the ISP and the access unit; the ISP, the computing unit and the power supply unit are respectively connected to the access unit; and the power supply unit is further connected to the deserializer and the power receiving unit.

14. The system of claim 13, wherein, in a case where the system comprises a plurality of vehicle-carried cameras, deserializers connected to serializers of the vehicle-carried cameras are jointly connected to one access unit, and ISPs connected to the deserializers are jointly connected to the access unit; and
a control signal between the access unit and each deserializer is an IC signal, a control signal between the access unit and each ISP is an IIC signal, a control signal between the access unit and the power supply unit is an IIC signal, and the plurality of cameras share one IC communication interface.

15. An electronic device, comprising:
at least one processor; and
a memory connected in communication with the at least one processor;
wherein the memory stores an instruction executable by the at least one processor, and the instruction, when executed by the at least one processor, enables the at least one processor to execute:
initiating an error event handling task in response to an interrupt signal of an error event; wherein the interrupt signal is used to indicate that a target video link is faulty, and the target video link comprising a target camera and a vehicle-carried controller connected to the target camera; and
performing fault recovery on a fault location in the target video link based on an interrupt type corresponding to the interrupt signal and information of the target camera.

16. The electronic device of claim 15, wherein the instruction, when executed by the at least one processor, enables the at least one processor to further execute:
executing a video link detection task to obtain a video link state; and
determining the interrupt type corresponding to the interrupt signal according to the video link state.

17. The electronic device of claim 16, wherein the instruction, when executed by the at least one processor, enables the at least one processor to execute the determining of the interrupt type corresponding to the interrupt signal according to the video link state, by:
receiving a first interrupt signal from a deserializer of the vehicle-carried controller, wherein the first interrupt signal corresponds to a first interrupt type; and the first interrupt signal is generated by the deserializer in a case where a preset error type is monitored in the video link state of the target video link.

18. The electronic device of claim 17, wherein the error type comprises one or more of: physical layer disconnection, a physical layer Cyclic Redundancy Check (CRC) error, a Forward Error Correction (FEC) error reaching an error threshold, a physical signal eye width being less than a preset threshold, or a physical signal eye height being less than a preset threshold.

19. The electronic device of claim 16, wherein the instruction, when executed by the at least one processor, enables the at least one processor to execute the determining of the interrupt type corresponding to the interrupt signal according to the video link state, by:
counting the number of dropped frames in the target video link according to the video link state; and
generating a second interrupt signal, in a case where the number of dropped frames reaches an interrupt trigger threshold, wherein the second interrupt signal corresponds to a second interrupt type.

20. A non-transitory computer-readable storage medium storing a computer instruction thereon, wherein the computer instruction is used to cause a computer to execute the method of claim 1.
